(19) United States
(12) Patent Application Publication
(10) Pub. No.: US 2025/0217711 A1
(43) Pub. Date: Jul. 3, 2025

(54) MACHINE LEARNING APPARATUS, MACHINE LEARNING METHOD, AND COMPUTER READABLE MEDIUM

(71) Applicant: Mitsubishi Electric Corporation, Tokyo (JP)

(72) Inventor: Tsunato NAKAI, Tokyo (JP)

(73) Assignee: Mitsubishi Electric Corporation, Tokyo (JP)

(21) Appl. No.: 19/080,628

(22) Filed: Mar. 14, 2025

Related U.S. Application Data
(63) Continuation of application No. PCT/JP2022/042101, filed on Nov. 11, 2022.

(51) Int. Cl. G06N 20/00

(52) U.S. Cl. CPC G06N 20/00

(57) ABSTRACT

A first learning unit (22) generates a first learning model by employing each of n pieces of learning data, as a subject, and performing training using subject learning data. A model integration unit (23) generates an integrated model by integrating m pieces of first learning models selected from n pieces of first learning models. A data generation unit (24) generates new learning data by rewriting a label assigned to subject data with a soft label which is a result obtained by giving to the integrated model, the subject data which is learning data other than learning data used for the training in the generation of the m pieces of first learning models that are the basis of the integrated models, as input. A second learning unit (25) generates a second learning model by performing training using the new learning data.

### CROSS REFERENCE TO RELATED APPLICATIONS

This application is a Continuation of PCT International Application No. PCT/JP2022/042101 filed on Nov. 11, 2022, all of which is hereby expressly incorporated by reference into the present application.

### TECHNICAL FIELD

The present disclosure relates to a method of training a machine learning model.

### BACKGROUND ART

The existence of a membership inference attack has been identified as a privacy problem in machine learning. The membership inference attack is an attack like the following. Normal input data is given to a machine learning model (hereinafter referred to as a target model) to be attacked, and an inference result responded by the target model is observed. This specifies whether or not the input data is included in learning data of the target model (=whether or not the input data is a membership).

Patent Literature 1 and Non-Patent Literatures 1 and 2 describe countermeasures against a membership inference attack.

In Patent Literature 1, learning data is divided into data that includes privacy information and data that does not include privacy information. The learning data that includes privacy information is used for training of only an input layer of a machine learning model. The learning data that does not include privacy information is used for re-training of all layers of the machine learning model. The re-trained machine learning model has resistance to the membership inference attack.

In Non-Patent Literature 1, learning data that is unlabeled and does not include privacy information is assigned a label (hereinafter referred to as a soft label), using a machine learning model trained on learning data that includes privacy information. The learning data that does not include privacy information is, for example, public data. Another machine learning model is trained on the learning data to which the soft label is attached. This trained machine learning model has resistance to the membership inference attack.

In Non-Patent Literature 2, initial learning data is divided into a constant number n pieces of sets. For each of the n pieces of sets, n−1 pieces of sets that exclude the set are set as learning data. That is, n pieces of learning data that have the n−1 pieces of sets are set. Training is performed using each of the n pieces of learning data, and a machine learning model corresponding to each of the n pieces of learning data is generated. For each of n pieces of machine learning models, a set that is not included in the learning data used for the training of a subject machine learning model is given as input to the subject machine learning model to obtain a soft label. The label of the set given as the input is rewritten with the soft label, and it is considered as new learning data. Then, the machine learning model is trained using the new learning data. This trained machine learning model has resistance to the membership inference attack.

### CITATION LIST

### Patent Literature

[Patent Literature 1] JP 2021-193533 A

### Non-Patent Literature

[Non-Patent Literature 1] Virat Shejwalkar et. al, “Membership Privacy for Machine Learning Models Through Knowledge Transfer”, AAAI2021
[Non-Patent Literature 2] Rishav Chourasia et. al, “Knowledge Cross-Distillation for Membership Privacy”, PETS2022

### SUMMARY OF INVENTION

### Technical Problem

The countermeasures described in Patent Literature 1 and Non-Patent Literature 1 require-learning data that does not include privacy information. In fields such as medicine and finance, since sensitive data may be used for machine learning, it is difficult to prepare the learning data that does not include privacy information.

The countermeasure described in Non-Patent Literature 2 does not require-learning data that does not include privacy information. However, the countermeasure described in Non-Patent Literature 2 requires additional training of n×(n−1) pieces of learning data, depending on the number of divisions n of the learning data. Therefore, an amount of calculation according to the countermeasure is larger than that of other conventional countermeasures.

The present disclosure aims to reduce an amount of calculation while eliminating the need for learning data that does not include private information, and to provide resistance to a membership inference attack.

### Solution to Problem

A machine learning apparatus according to the present disclosure includes: a first learning unit to generate n pieces of first learning models by employing each of n pieces of first learning data to which a label is assigned, where an integer n is equal to or greater than 3, as a subject, performing training using subject learning data, and generating the first learning model corresponding to the subject learning data;
a model integration unit to generate an integrated model by integrating m pieces of first learning models selected from the n pieces of first learning models generated by the first learning unit, where an integer m is less than n;
a data generation unit to generate new learning data by rewriting a label assigned to subject data with a soft label which is a result obtained by giving the subject data as input to the integrated model generated by the model integration unit, the subject data being learning data other than learning data used for training in the generation of the m pieces of first learning models that are the basis of the integrated model; and
a second learning unit to generate a second learning model by performing training using the new learning data generated by the data generation unit.

### Advantageous Effects of Invention

In the present disclosure, a first learning model generated by performing training using a subject learning data is integrated and an integrated model is generated, and new learning data is generated by the integrated model. Thereby, it is possible to reduce an amount of calculation while eliminating the need for learning data that does not include privacy information, and to provide resistance to a membership inference attack.

### BRIEF DESCRIPTION OF DRAWINGS

FIG. 1 is a configuration diagram of a machine learning apparatus 10 according to Embodiment 1.

FIG. 2 is a flowchart illustrating a processing flow of the machine learning apparatus 10 according to Embodiment 1.

FIG. 3 is an explanatory diagram of a specific example of operation of the machine learning apparatus 10 according to Embodiment 1.

FIG. 4 is a configuration diagram of the machine learning apparatus 10 according to Modification 2.

FIG. 5 is a configuration diagram of the machine learning apparatus 10 according to Embodiment 2.

FIG. 6 is a flowchart illustrating a processing flow of the machine learning apparatus 10 according to Embodiment 2.

FIG. 7 is an explanatory diagram of a specific example of the operation of the machine learning apparatus 10 according to Embodiment 2.

### DESCRIPTION OF EMBODIMENTS

### Embodiment 1

### Description of Configuration

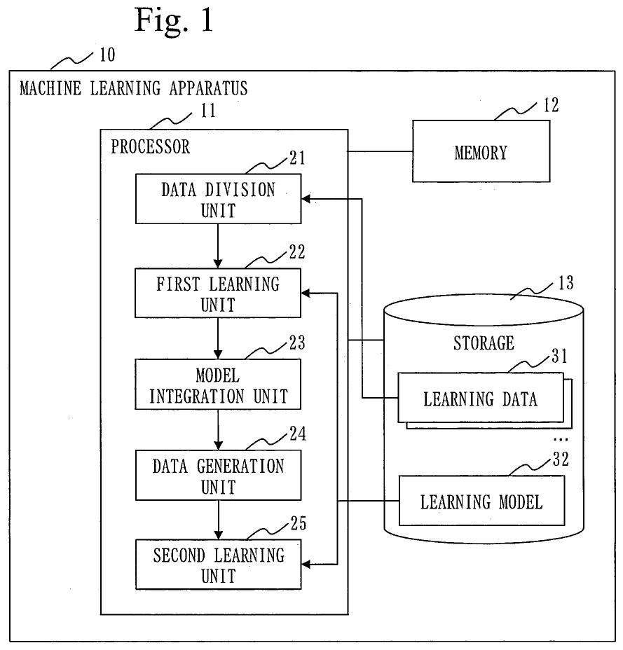

A configuration of a machine learning apparatus 10 according to Embodiment 1 will be described with reference to FIG. 1.

The machine learning apparatus 10 is a computer.

The machine learning apparatus 10 includes pieces of hardware which are a processor 11, a memory 12, and a storage 13. The processor 11 is connected to other pieces of hardware via signal lines and controls the other pieces of hardware.

The processor 11 is an IC that performs processing. IC is an abbreviation for Integrated Circuit. Specific examples of the processor 11 are a CPU, a DSP, and a GPU. CPU is an abbreviation for Central Processing Unit. DSP is an abbreviation for Digital Signal Processor. GPU is an abbreviation for Graphics Processing Unit.

The memory 12 is a storage device that stores data temporarily. Specific examples of the memory 12 are an SRAM and a DRAM. SRAM is an abbreviation for Static Random Access Memory. DRAM is abbreviation for Dynamic Random Access Memory.

The storage 13 is a storage device that keeps data. A specific example of the storage 13 is an HDD. HDD is an abbreviation for Hard Disk Drive. Alternatively, the storage 13 may be a portable recording medium such as an SD (registered trademark) memory card, CompactFlash (registered trademark), NAND flash, a flexible disk, an optical disc, a compact disc, a Blu-ray (registered trademark) disc, and a DVD. SD is abbreviation for Secure Digital. DVD is abbreviation for Digital Versatile Disk.

The machine learning apparatus 10 includes a data division unit 21, a first learning unit 22, a model integration unit 23, a data generation unit 24, and a second learning unit 25, as functional components. The functions of the individual functional components of the machine learning apparatus 10 are implemented by software.

The storage 13 stores programs that implement the functions of the individual functional components of the machine learning apparatus 10. These programs are loaded into the memory 12 by the processor 11 and executed by the processor 11. Thereby, the functions of the individual functional components of the machine learning apparatus 10 are implemented.

The storage 13 stores a plurality of pieces of learning data 31 and a learning model 32. Each learning data 31 has a label attached and includes privacy information.

FIG. 1 illustrates only one processor 11. However, there may be a plurality of processors 11, and the plurality of processors 11 may cooperate with each other to execute the programs that implement the individual functions.

### Description of Operation

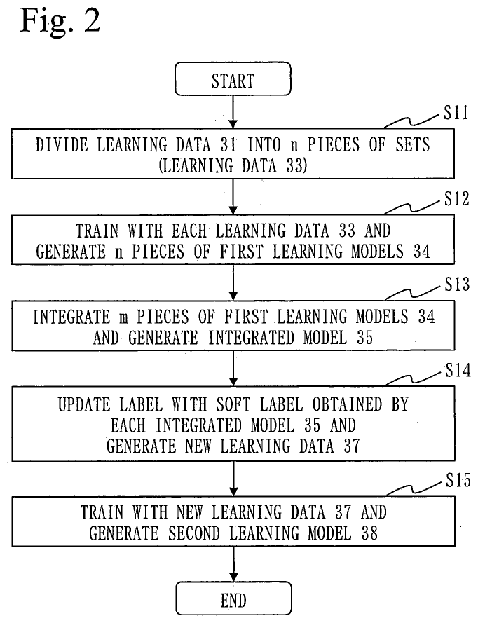

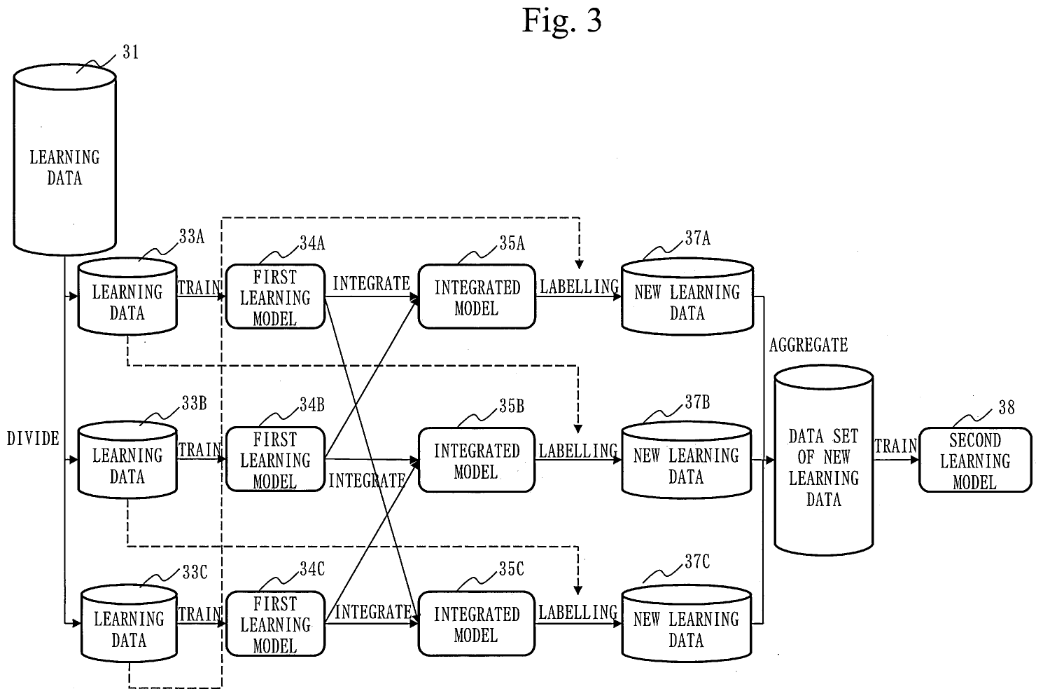

Operation of the machine learning apparatus 10 according to Embodiment 1 will be described with reference to FIGS. 2 and 3.

An operation procedure of the machine learning apparatus 10 according to Embodiment 1 is equivalent to a machine learning method according to Embodiment 1. Further, a program that implements the operation of the machine learning apparatus 10 according to Embodiment 1 is equivalent to a machine learning program according to Embodiment 1.

A processing flow of the machine learning apparatus 10 according to Embodiment 1 will be described with reference to FIG. 2.

### Step S11: Data Division Process

A data division unit 21 reads a plurality of pieces of learning data 31 stored in the storage 13 into the memory 12. The data division unit 21 divides the read plurality of pieces of learning data 31 into a constant number n pieces of sets. n is an integer equal to or greater than 3. The data division unit 21 equally divides the plurality of pieces of learning data 31 such that the number of pieces of learning data 31 included in each set is approximately equal, for example. Thereby, n pieces of data sets (hereinafter referred to as learning data 33) of learning data are generated. The data division unit 21 writes the n pieces of learning data 33 into the memory 12.

### Step S12: First Learning Process

The first learning unit 22 reads the n pieces of learning data 33 generated in step S11 and the learning model 32 from the memory 12. The first learning unit 22 sets each of the n pieces of learning data 33 as subject learning data 33. The first learning unit 22 performs training on the learning model 32, using the subject learning data 33, and generates a first learning model 34 corresponding to the subject learning data 33. Thereby, n pieces of first learning models 34 are generated. The first learning unit 22 writes the n pieces of first learning models 34 into the memory 12.

### Step S13: Model Integration Process

The model integration unit 23 reads from the memory 12, the n pieces of first learning models 34 generated in step S12. The model integration unit 23 generates an integrated model 35 by integrating m pieces of first learning models 34 selected from the n pieces of first learning models 34. m is an integer less than n. Here, the model integration unit 23 generates the integrated model 35 for each combination of the m pieces of first learning models 34 that can be selected from the n pieces of first learning models. The model integration unit 23 writes the integrated model 35 into the memory 12 for each combination.

The model integration unit 23 adds up the parameters of the m pieces of first learning models 34, and performs arithmetic processing such as additive averaging or weighted averaging for each parameter. Thereby, the model integration unit 23 generates the integrated model 35 by integrating the m pieces of first learning models 34.

In Embodiment 1, it is assumed that m=n−1. There are n combinations of selecting n−1 pieces of first learning models 34 from the n pieces of first learning models 34. That is, there are the n combinations which are a combination of the remaining n−1 pieces of first learning models 34 in which the 1st first learning model 34 has been excluded from the n pieces of first learning models 34, a combination of the remaining n−1 pieces of first learning models 34 in which the 2nd first learning model 34 has been excluded from the n pieces of first learning models 34, . . . and a combination of the remaining n−1 pieces of first learning models 34 in which the nth first learning model 34 has been excluded from the n pieces of first learning models 34.

Therefore, the model integration unit 23 generates the integrated model 35 by integrating for each of the n combinations, the first learning models 34 of the combination. As a result, n pieces of integrated models 35 are generated.

### Step S14: Data Generation Process

The data generation unit 24 reads from the memory 12, each integrated model 35 generated in step S13. The data generation unit 24 sets each integrated model 35 as a subject integrated model 35.

The data generation unit 24 provides the subject integrated model 35 with subject data 36, which is the learning data 33 other than the learning data 33 used for the training in the generation of the m pieces of first learning models that are the basis of the subject integrated model 35, as input, to cause the subject integrated model 35 to perform inference. The data generation unit 24 obtains a soft label which is a result obtained through the inference by the subject integrated model 35. The data generation unit 24 generates new learning data 37 by rewriting the label that is assigned to the subject data 36 with the soft label. The data generation unit 24 aggregates pieces of new learning data 37 each of which is generated for each integrated model 35, and writes the aggregated data into the memory 12 as a data set of the new learning data 37.

In Embodiment 1, the data generation unit 24 reads the n pieces of integrated models 35. The data generation unit 24 sets each of the n pieces of integrated models 35 as the subject integrated model 35.

The data generation unit 24 provides the subject integrated model 35 with the subject data 36, which is the learning data 33 other than the learning data 33 used for the training in the generation of the n−1 pieces of first learning models that are the basis of the integrated model 35, as input, to cause the subject integrated model 35 to perform inference. When the subject integrated model 35 is generated from the combination of the remaining n−1 pieces of first learning models 34 in which the 1st first learning model 34 has been excluded, the 1st first learning model 34 is the subject data 36, for example. Similarly, when the subject integrated model 35 is generated from the combination of the remaining n−1 pieces of first learning models 34 in which the 2nd first learning model 34 has been excluded, the 2nd first learning model 34 is the subject data 36. The data generation unit 24 generates the new learning data 37 by rewriting the label that is assigned to the subject data 36 with the soft label.

The data generation unit 24 aggregates the new learning data 37 generated for each of the n pieces of integrated models 35, and writes the aggregated data into the memory 12 as the data set of the new learning data 37.

### Step S15: Second Learning Process

The second learning unit 25 reads from the memory 12, the data set of the new learning data 37 generated in step S14 and the learning model 32. The second learning unit 25 performs training on the learning model 32, using the data set of the new learning data 37, and generates a second learning model 38.

A specific example of the operation of the machine learning apparatus 10 according to Embodiment 1 will be described with reference to FIG. 3.

FIG. 3 illustrates an example in a case where n which is a division number is 3 and m is n−1.

In step S11, the data division unit 21 divides the learning data 31 that includes privacy information into 3 (=n) equal pieces.

Thereby, learning data 33A, learning data 33B, and learning data 33C are generated.

In step S12, the first learning unit 22 sets each of the three pieces of learning data 33 as the subject learning data 33. The first learning unit 22 trains the learning model 32 using the subject learning data 33, and generates the first learning model 34 corresponding to the subject learning data 33.

Thereby, three pieces of learning data 33 are generated: a first learning model 34A trained on learning data 33A; a first learning model 34B trained on learning data 33B; and a first learning model 34C trained on learning data 33C.

In step S13, the model integration unit 23 sets each combination of 2 (=m=n−1) pieces of first learning models 34 that can be selected from the three pieces of first learning models 34, as a subject combination. The model integration unit 23 generates the integrated model 35 by integrating the two pieces of first learning models 34 included in the subject combination.

Thereby, three pieces of integrated models 35 are generated: an integrated model 35A in which the first learning model 34A and the first learning model 34B are integrated; an integrated model 35B in which the first learning model 34B and the first learning model 34C are integrated; and an integrated model 35C in which the first learning model 34A and the first learning model 34C are integrated.

In step S14, the data generation unit 24 sets each of the three pieces of integrated models 35 as the subject integrated model 35. The data generation unit 24 provides the subject integrated model 35 with the subject data 36, which is the learning data 33 not used for the training of the two pieces of first learning models 34 that are the basis of the subject integrated model 35, as input. The integrated model 35A is provided with the learning data 33C that is not used for the training of the first learning model 34A and the first learning model 34B, as input. The integrated model 35B is provided with the learning data 33A that is not used for the training of the first learning model 34B and the first learning model 34C, as input. The integrated model 35C is provided with the learning data 33B that is not used for the training of the first learning model 34A and the first learning model 34C, as input.

The data generation unit 24 generates the new learning data 37 by rewriting the label that is assigned to the subject data 36 with the soft label which is a result obtained through the inference by the subject integrated model 35. That is, the label of the learning data 33C is rewritten with the soft label obtained by the integrated model 35A, and the new learning data 37A is generated. The label of the learning data 33A is rewritten with the soft label obtained by the integrated model 35B, and the new learning data 37B is generated. The label of the learning data 33B is rewritten with the soft label obtained by the integrated model 35C, and the new learning data 37C is generated.

The data generation unit 24 aggregates the new learning data 37A, the new learning data 37B, and the new learning data 37C, and generates a data set of the new learning data 37.

In step S15, the second learning unit 25 performs training on the learning model 32, using the data set of the new learning data 37, and generates the second learning model 38.

Here, the training of the learning model 32 is performed by, for example, deep learning. The training of the learning model 32 is not limited to the deep learning, and may be performed by, for example, arithmetic such as regression, decision tree learning, Bayesian, or clustering.

### Effects of Embodiment 1

As described above, the machine learning apparatus 10 according to Embodiment 1 generates a plurality of first learning models 34, using the learning data 33 obtained by dividing the learning data 31 that includes privacy information, and generates the integrated model 35 by integrating the first learning models 34. Then, the machine learning apparatus 10 generates the new learning data 37 by a soft label obtained by the integrated model 35, and generates the second learning model 38 by training the learning model 32 on the new learning data 37. That is, the second learning model 38 is generated by training the learning model 32 using the new learning data 37 from which the privacy information of the original learning data 31 has been removed.

Thereby, the machine learning apparatus 10 according to Embodiment 1 can generate the second learning model 38 that has resistance to a membership inference attack. That is, the machine learning apparatus 10 can generate the second learning model 38 that has resistance to a membership inference attack without preparing learning data that does not include privacy information, as in Patent Literature 1 and Non-Patent Literature 1.

Further, the machine learning apparatus 10 according to Embodiment 1 generates the first learning model 34 for each of the plurality of learning data 33 obtained by dividing the learning data 31, and generates the integrated model 35 by aggregating the first learning models 34. That is, the machine learning apparatus 10 does not perform additional learning as in Non-Patent Literature 2, but integrates the first learning models 34. Thereby, it is possible to generate the second learning model 38 that has resistance to a membership inference attack with a reduced amount of calculation compared to that in the technique of Non-Patent Literature 2.

Specifically, in order to have the resistance to the membership inference attack, the machine learning apparatus 10 requires: (1) additional one-time training; and (2) average calculation of the parameters of the first learning model 34 and assignment of a soft label, which is lightweight processing. The one-time training to be additionally performed is training of n pieces of learning data 33 corresponding to the number of divisions n of the learning data 31. The average calculation of the parameters of the first learning model 34 is a calculation in the processing of the integration of the first learning models 34.

### Other Configurations

### Modification 1

In step S15, the second learning unit 25 may perform training using data obtained by adding the learning data 31 to the data set of the new learning data 37 at a reference ratio.

Thereby, it is expected that the learning accuracy will improve. However, the higher the ratio of the learning data 31 to the new learning data 37, the lower the resistance of the second learning model 38 to a membership inference attack. Therefore, it is necessary to set the reference ratio in advance according to the required resistance to a membership inference attack.

### Modification 2

In Embodiment 1, the individual functional components are implemented by software. However, Modification 2 may be possible where the individual functional components are implemented by hardware. Modification 2 will be described in terms of differences from Embodiment 1.

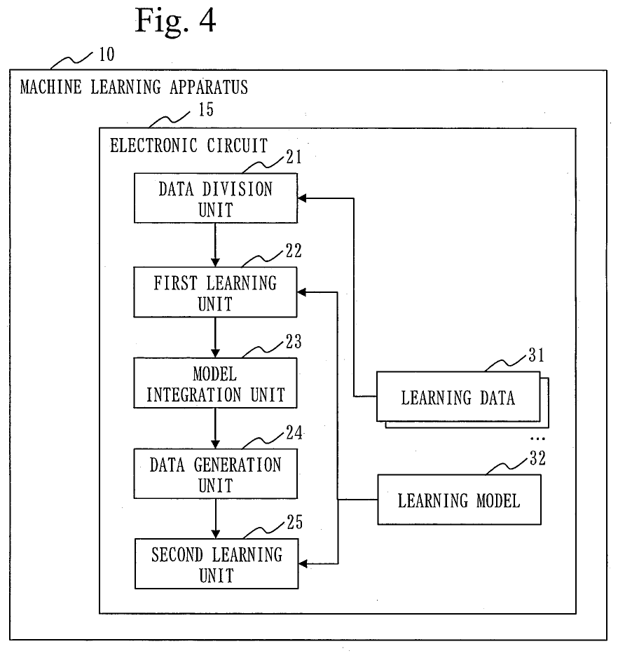

A configuration of the machine learning apparatus 10 according to Modification 2 will be described with reference to FIG. 4.

When the individual functional components are implemented by hardware, the machine learning apparatus 10 includes an electronic circuit 15 instead of the processor 11, the memory 12, and the storage 13. The electronic circuit 15 is a dedicated circuit that implements the functions of the individual functional components and the functions of the memory 12 and the storage 13.

A single circuit, a composite circuit, a programmed processor, a parallel-programmed processor, a logic IC, a GA, an ASIC, or an FPGA may be employed as the electronic circuit 15. GA is an abbreviation for Gate Array. ASIC is an abbreviation for Application Specific Integrated Circuit. FPGA is an abbreviation for Field-Programmable Gate Array.

The individual functional components may be implemented by one electronic circuit 15, or may be implemented by a plurality of electronic circuits 15 through distribution.

### Modification 3

Modification 3 may be possible where some of the functional components are implemented by hardware and the remaining functional components are implemented by software.

The processor 11, the memory 12, the storage 13, and the electronic circuit 15 are referred to as processing circuitry. That is, the functions of the individual functional components are implemented by the processing circuitry.

### Embodiment 2

Embodiment 2 differs from Embodiment 1 in that re-training of the integrated model 35 is performed. In Embodiment 2, this difference will be described and the description of the same points will be omitted.

### Description of Configuration

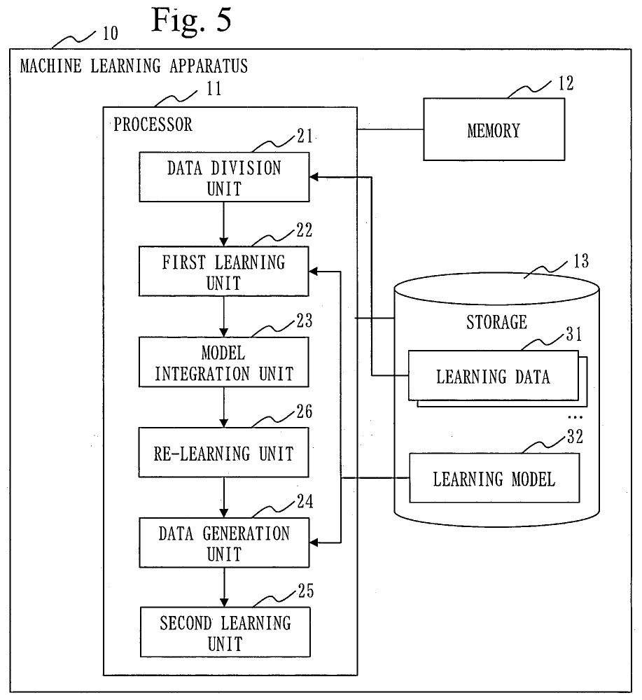

A configuration of the machine learning apparatus 10 according to Embodiment 2 will be described with reference to FIG. 5.

The machine learning apparatus 10 differs from the machine learning apparatus 10 illustrated in FIG. 10 in that the machine learning apparatus 10 includes a re-learning unit 26 as a functional component. The re-learning unit 26 is implemented by software or hardware as with the other functional components.

### Description of Operation

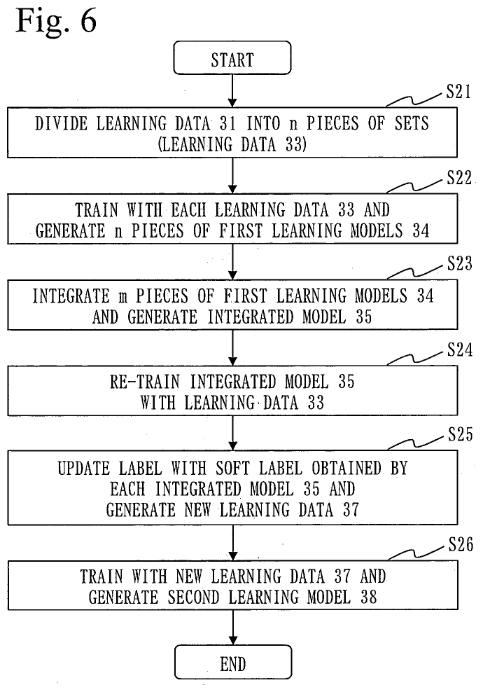

A processing flow of the machine learning apparatus 10 according to Embodiment 2 will be described with reference to FIG. 6.

The processes in steps S21 to S23 are the same as the processes in steps S11 to S13 of FIG. 2. The processes in steps S25 and S26 are the same as the processes in steps S14 and S15 of FIG. 2.

However, in step S25, the new learning data 37 is generated using the integrated model 35 that has performed re-training in step S24.

### Step S24: Re-Learning Process

The re-learning unit 26 reads from the memory 12, each integrated model 35 generated in step S23. The re-learning unit 26 sets each integrated model 35 as a subject integrated model 35.

The re-learning unit 26 performs re-training of the subject integrated model 35, using the learning data 33 used for the training in the generation of the m pieces of first learning models 34 that are the basis of the subject integrated model 35. Each first learning model 34 is generated using one piece of learning data 33. Therefore, the re-learning unit 26 performs training using the m pieces of learning data 33 used in the generation of the m pieces of first learning models 34.

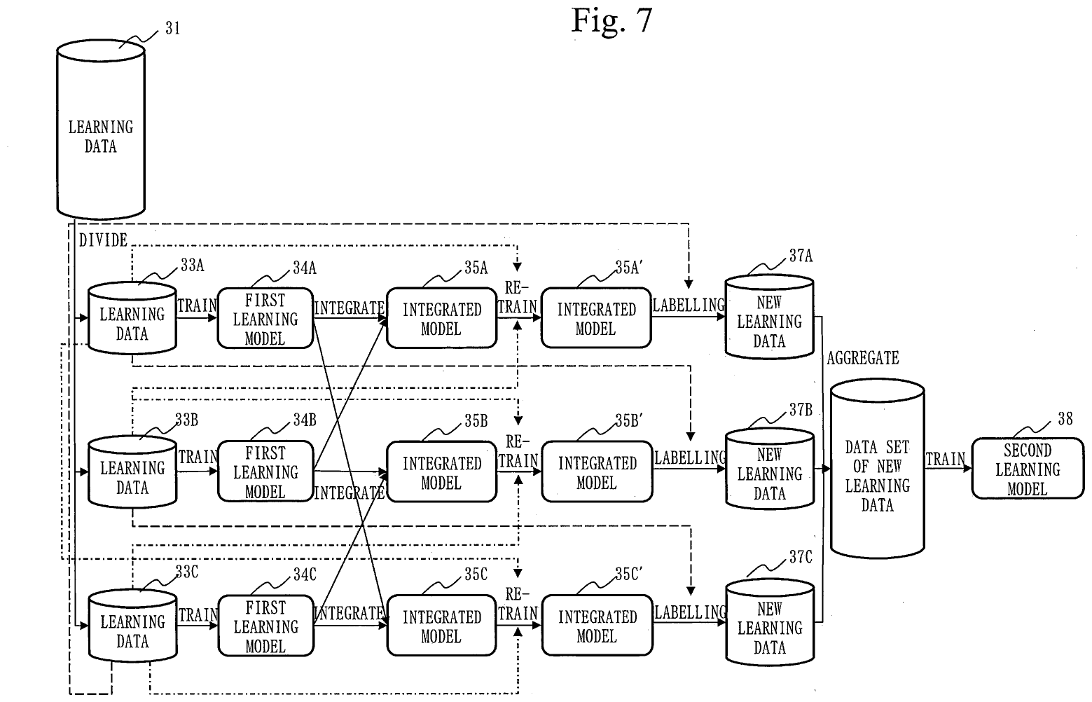

A specific example of the operation of the machine learning apparatus 10 according to Embodiment 2 will be described with reference to FIG. 7.

FIG. 7 illustrates an example in a case where n which is a division number is 3 and m is n−1, as in the example of FIG. 3.

The processes of steps S21 to S23 generate from the integrated model 35A, three pieces of integrated models 35 of the integrated model 35C, as in the example of FIG. 3.

In step S24, the re-learning unit 26 sets each of the three pieces of integrated models 35, as the subject integrated model 35. The data generation unit 24 re-trains the subject integrated model 35 using the learning data 33 used for the training of the two pieces of first learning models 34 that are the basis of the subject integrated model 35.

The integrated model 35A is re-trained using the learning data 33A and the learning data 33B used for the training of the first learning model 34A and the first learning model 34B. Thereby, the integrated model 35A′ is generated. The integrated model 35B is re-trained using the learning data 33B and the learning data 33C used for the training of the first learning model 34B and the first learning model 34C. Thereby, the integrated model 35B′ is generated. The integrated model 35C is re-trained using the learning data 33A and the learning data 33C used for the training of the first learning model 34A and the first learning model 34C. Thereby, the integrated model 35C′ is generated.

In step S25, the data generation unit 24 sets each of the three pieces of re-trained integrated models 35, as the subject integrated model 35. That is, the data generation unit 24 sets each of the integrated model 35A′, the integrated model 35B′, and the integrated model 35C′, as the subject integrated model 35. Then, the data generation unit 24 generates the new learning data 37 from the subject integrated model 35, as in the example of FIG. 3.

In step S26, the second learning unit 25 performs training on the learning model 32, using the data set of the new learning data 37, and generates the second learning model 38, as in the example of FIG. 3.

### Effects of Embodiment 2

As described above, the machine learning apparatus 10 according to Embodiment 2 re-trains the integrated model 35. Thereby, it is possible to improve the inference accuracy of the integrated model 35, compared to that of Embodiment 1. If the inference accuracy of the integrated model 35 is improved, it is possible to assign a soft level to the new learning data 37 with high accuracy. As a result, it is possible to generate the second learning model 38 with high inference accuracy.

The word “unit” appearing in the above description may be replaced with “circuit”, “step”, “procedure”, “process”, or “processing circuitry”.

The embodiments and modifications of the present disclosure have been described above. Among these embodiments and modifications, some may be practiced by combination. Alternatively, one or some of these embodiment and modifications may be practiced partly. The present disclosure is not limited to the above embodiments and modifications, and various modifications can be made as necessary.

### REFERENCE SIGNS LIST

10: machine learning apparatus; 11: processor; 12: memory; 13: storage; 15: electronic circuit; 21: data division unit; 22: first learning unit; 23: model integration unit; 24: data generation unit; 25: second learning unit; 26: re-learning unit; 31: learning data; 32: learning model; 33: learning data; 34: first learning model; 35: integrated model; 36: subject data; 37: new learning data; 38: second learning model.

1. A machine learning apparatus comprising:
processing circuitry:
to generate n pieces of first learning models by employing each of n pieces of first learning data to which a label is assigned, where an integer n is equal to or greater than 3, as a subject, performing training using subject learning data, and generating the first learning model corresponding to the subject learning data;
to generate an integrated model by integrating m pieces of first learning models selected from the n pieces of generated first learning models, where an integer m is less than n;
to generate new learning data by rewriting a label assigned to subject data with a soft label which is a result obtained by giving the subject data as input to the generated integrated model, the subject data being learning data other than learning data used for training in the generation of the m pieces of first learning models that are the basis of the integrated model; and
to generate a second learning model by performing training using the generated new learning data.

2. The machine learning apparatus according to claim 1, wherein
the processing circuitry generates the integrated model for each combination of the m pieces of first learning models that can be selected from the n pieces of first learning models, and
the processing circuitry generates new learning data by employing each generated integrated model, as a subject, and rewriting a label assigned to subject data with a soft label which is a result obtained by giving the subject data as input to a subject integrated model, the subject data being learning data other than learning data used for training in the generation of the m pieces of first learning models that are the basis of the subject integrated model.

3. The machine learning apparatus according to claim 1, wherein
the integer m is n−1.

4. The machine learning apparatus according to claim 2, wherein
the integer m is n−1.

5. The machine learning apparatus according to claim 1, wherein
the processing circuitry generates the second learning model by performing training using data to which the learning data is added to the new learning data with a reference ratio.

6. The machine learning apparatus according to claim 2, wherein
the processing circuitry generates the second learning model by performing training using data to which the learning data is added to the new learning data with a reference ratio.

7. The machine learning apparatus according to claim 3, wherein
the processing circuitry generates the second learning model by performing training using data to which the learning data is added to the new learning data with a reference ratio.

8. The machine learning apparatus according to claim 4, wherein
the processing circuitry generates the second learning model by performing training using data to which the learning data is added to the new learning data with a reference ratio.

9. The machine learning apparatus according to claim 1, wherein
the processing circuitry performs re-training of the integrated model using learning data used for training in the generation of the m pieces of first learning models that are the basis of the integrated model, and
the processing circuitry generates the new learning data using the integrated model to which re-training is performed.

10. The machine learning apparatus according to claim 2, wherein
the processing circuitry performs re-training of the integrated model using learning data used for training in the generation of the m pieces of first learning models that are the basis of the integrated model, and
the processing circuitry generates the new learning data using the integrated model to which re-training is performed.

11. The machine learning apparatus according to claim 3, wherein
the processing circuitry performs re-training of the integrated model using learning data used for training in the generation of the m pieces of first learning models that are the basis of the integrated model, and
the processing circuitry generates the new learning data using the integrated model to which re-training is performed.

12. The machine learning apparatus according to claim 4, wherein
the processing circuitry performs re-training of the integrated model using learning data used for training in the generation of the m pieces of first learning models that are the basis of the integrated model, and
the processing circuitry generates the new learning data using the integrated model to which re-training is performed.

13. The machine learning apparatus according to claim 5, wherein
the processing circuitry performs re-training of the integrated model using learning data used for training in the generation of the m pieces of first learning models that are the basis of the integrated model, and
the processing circuitry generates the new learning data using the integrated model to which re-training is performed.

14. The machine learning apparatus according to claim 6, wherein
the processing circuitry performs re-training of the integrated model using learning data used for training in the generation of the m pieces of first learning models that are the basis of the integrated model, and
the processing circuitry generates the new learning data using the integrated model to which re-training is performed.

15. The machine learning apparatus according to claim 7, wherein
the processing circuitry performs re-training of the integrated model using learning data used for training in the generation of the m pieces of first learning models that are the basis of the integrated model, and
the processing circuitry generates the new learning data using the integrated model to which re-training is performed.

16. The machine learning apparatus according to claim 8, wherein
the processing circuitry performs re-training of the integrated model using learning data used for training in the generation of the m pieces of first learning models that are the basis of the integrated model, and
the processing circuitry generates the new learning data using the integrated model to which re-training is performed.

17. A machine learning method comprising:
generating n pieces of first learning models by employing each of n pieces of first learning data to which a label is assigned, where an integer n is equal to or greater than 3, as a subject, performing training using subject learning data, and generating the first learning model corresponding to the subject learning data;
generating an integrated model by integrating m pieces of first learning models selected from the n pieces of first learning models, where an integer m is less than n;
generating new learning data by rewriting a label assigned to subject data with a soft label which is a result obtained by giving the subject data as input to the integrated model, the subject data being learning data other than learning data used for training in the generation of the m pieces of first learning models that are the basis of the integrated model; and
generating a second learning model by performing training using the new learning data.

18. A non-transitory computer readable medium storing a machine learning program for causing a computer to function as a machine learning apparatus to execute:
a first learning process to generate n pieces of first learning models by employing each of n pieces of first learning data to which a label is assigned, where an integer n is equal to or greater than 3, as a subject, performing training using subject learning data, and generating the first learning model corresponding to the subject learning data;
a model integration process to generate an integrated model by integrating m pieces of first learning models selected from the n pieces of first learning models generated by the first learning process, where an integer m is less than n;
a data generation process to generate new learning data by rewriting a label assigned to subject data with a soft label which is a result obtained by giving the subject data as input to the integrated model generated by the model integration process, the subject data being learning data other than learning data used for training in the generation of the m pieces of first learning models that are the basis of the integrated model; and
a second learning process to generate a second learning model by performing training using the new learning data generated by the data generation process.
